(19) United States
(12) Patent Application Publication
(10) Pub. No.: US 2015/0122822 A1
(43) Pub. Date: May 7, 2015

(54) DRAIN PAN WITH BUILT-IN GLOVE

(71) Applicants: Paul Saffelle, Falls Church, VA (US); Brett A. Holleman, Arlington, VA (US)

(72) Inventors: Paul Saffelle, Falls Church, VA (US); Brett A. Holleman, Arlington, VA (US)

(21) Appl. No.: 14/073,101

(22) Filed: Nov. 6, 2013

(51) Int. Cl. F16N 31/00

(52) U.S. Cl. CPC F16N 31/002; F16N 2031/008
USPC 220/573; 29/426.1

(57) ABSTRACT

A drain pan with an attached glove.

### BACKGROUND OF THE INVENTION

The present invention relates to oil drain pans used for vehicle engines.

Engines employ parts which move very closely against each other at high speeds, often for prolonged periods of time. Internal combustion engines, such as found in automobiles, boats, lawn mowers, trains and airplanes, are typically lubricated With motor oils or other lubricants. The oil is often maintained in a reservoir beneath the engine that allows selective access to the reservoir, e.g., to allow draining or replacement of oil or lubricant. This motion causes friction, absorbing otherwise useful power produced by the engine and converting the energy to heat. Friction also wears away the contacting surfaces of such parts, which can lead to lower efficiency and degradation of the engine. This increases fuel consumption.

Lubricating oil creates a film between the surfaces of parts moving next to each other so as to minimize direct contact between them, decreasing friction, wear, and production of excessive heat, and protecting the engine. Motor oil also carries away heat from moving parts, which is helpful as materials tend to become softer and less abrasion-resistant at high temperatures.

Over time, engine oil breaks down and/or becomes contaminated, and the oil should be changed periodically for this reason. When the engine is not in operation, oil collects in an oil pan. Oil pans are detachable mechanisms made out of thin steel and bolted to the bottom of the crankcase, which houses the crankshaft. To maximize the function of the oil pan, it is often molded into a deeper section and mounted at the bottom of the crankcase to serve as an oil reservoir. An oil drain plug is typically located on the bottom of the oil pan. When an engine is at rest, the oil pan gathers the oil as it flows down from the sides of the crankcase.

The process of draining an engine oil pan or crankcase often requires draining the oil pan, and then removing the oil filter after oil has substantially drained from the pan. Unfortunately, some oil nearly always remains within the filter and immediately surrounding areas, occasionally resulting in spills of the remaining oil When the oil drain pan and/or filter are removed.

In the conventional oil pan with a drain plug, the drain plug can be removed to allow old oil to seep out of the oil pan during an oil exchange. The drain plug may then be screwed back into the drain hole after the used oil is drained out. Unscrewing conventional drain plugs with a wrench can result in oil escaping from the oil pan around the threads of the drain plug prior to the drain plug being entirely removed. This oil often ends up on the hands and/or arms of the mechanic or other person removing the oil drain plug and also, possibly, on the ground.

It may be desirable to loosen the fasteners securing the oil pan to the crankcase, before removing the oil pan entirely, or before removing the drain plug. Often clearance issues make it difficult to perform these procedures while operating outside of the oil pan.

The present invention allows persons who would not ordinarily change their motor oil a convenient way to do so. Specifically, by using the invention a person is able to avoid hand contact with the engine oil when draining.

Accordingly, it would be advantageous to provide an oil pan, and a method for using it, which can be changed quickly and without creating a mess.

### Definition Of Claim Terms

The following terms are used in the claims of the patent as filed and are intended to have their broadest meaning consistent with the requirements of law. Where alternative meanings are possible, the broadest meaning is intended. All words used in the claims are intended to be used in the normal, customary usage of grammar and the English language.

### SUMMARY OF THE INVENTION

The objects mentioned above, as well as other objects, are solved by the present invention, which overcomes disadvantages of prior drain pans and methods for using them, while providing new advantages not previously obtainable with such systems and methods.

One preferred embodiment includes a drain pan useful for draining oil from an engine, which includes a glove attached to a side or top of the pan. The glove preferably resides inside the drain pan, and the glove permits a user to manipulate items above the pan. In one preferred embodiment, a base end of the glove may be attached to the pan using one or more of the following attachment means: screws, bolts, rivets, adhesives, zippers, buttons or Velcro®. The glove may be made of rubber (e.g., neoprene), paper or plastic, and may be designed to be durable and reusable or, alternatively, to be disposable.

A method for using a drain pan with an attached glove also forms part of the present invention, and may include the steps of inserting a user's hand into the glove; using the glove to reach up to loosen fasteners associated with a crankcase of an engine, to allow oil to drain from the crankcase into the drain pan; and using the glove to remove the drain plug from the drain pan, and allowing oil to drain from the drain pan. The glove may also be used to replace the drain plug, and to tighten the fasteners associated with the crankcase.

### BRIEF DESCRIPTION OF THE DRAWINGS

The novel features which are characteristic of the invention are set forth in the appended claims. The invention itself, however, together with further objects and attendant advantages thereof, will be best understood by reference to the following description taken in connection with the accompanying drawings, in which:

FIG. 1 is a perspective view of one embodiment of the present invention connected to an oil drain pan;

FIG. 2 is a top and side perspective view of a portion of FIG. 1;

FIG. 3 is a side cross-sectional view along reference line 3-3 of FIG. 2; and

FIGS. 4A, 4B and 4C are sequential, side perspective views of a person using a preferred embodiment drain pan with built-in glove of the present invention.

### DETAILED DESCRIPTION OF THE PREFERRED EMBODIMENTS

Set forth below is a description of what are believed to be the preferred embodiments and/or best examples of the invention claimed. Future and present alternatives and modifications to this preferred embodiment are contemplated. Any alternatives or modifications which make insubstantial changes in function, in purpose, in structure, or in result are intended to be covered by the claims of this patent.

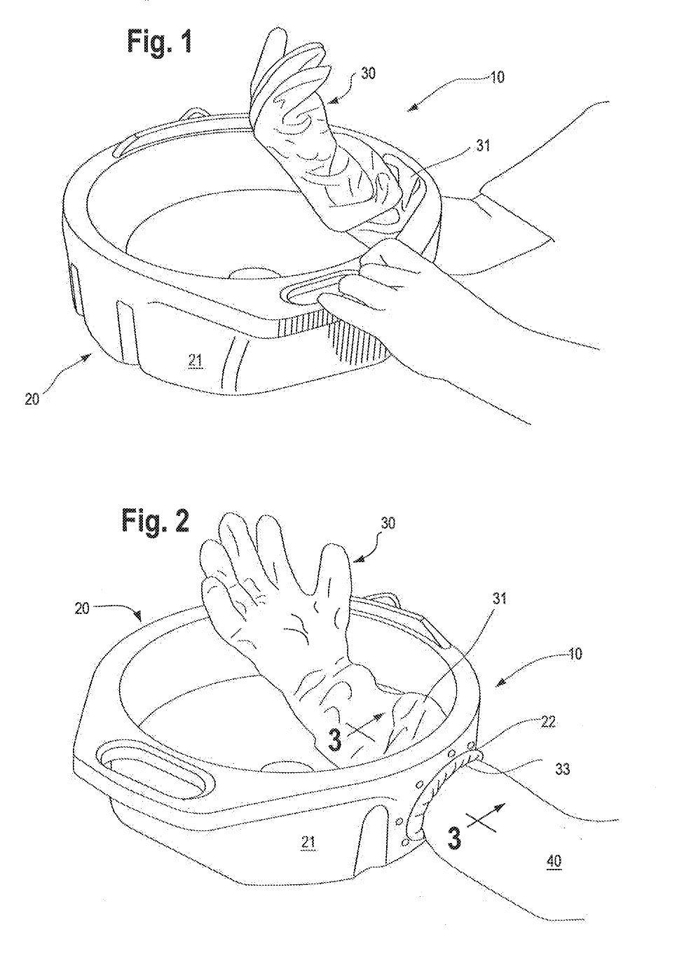

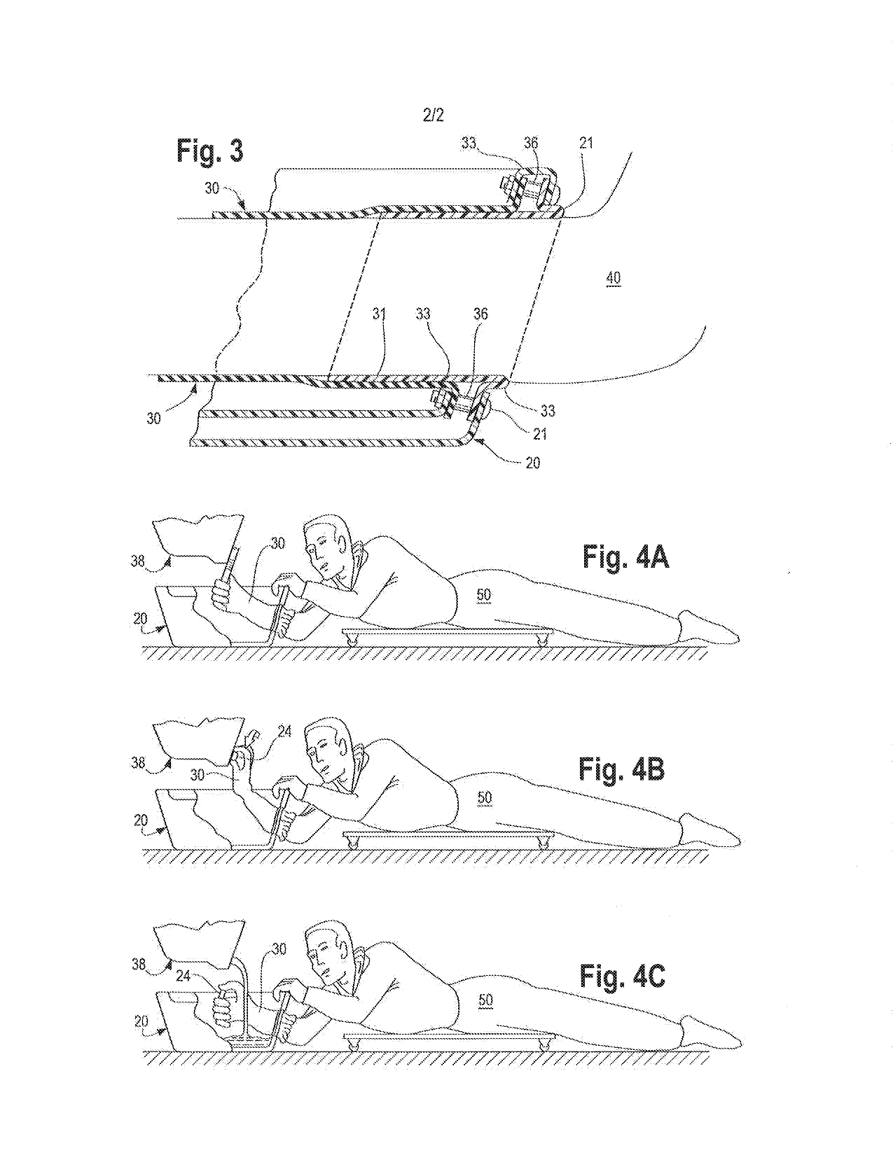

Referring first to FIG. 1, a preferred embodiment of the present invention is shown by reference numeral 10. Oil drain pan 20 includes a built-in glove 30 with an aperture 22 located on a side 21 of drain pan 20 for admitting a user's hand. Glove 30 preferably extends within the inner space of the drain pan. A base end 31 of glove 30 may be attached to the side 21 of drain pan 20 using any suitable fastening means, such as screws, bolts or rivets 36 (FIG. 3), or adhesive means such as glue, or zippers, buttons or Velcro®. Preferably the base end 31 of glove 30 is attached to aperture 22 of drain pan 20 in a leak-proof manner. For this purpose, the base end 31 of glove 30 may include a plastic or rubber liner 33, which may be attached to an inside surface of base end 31 and also attached to an inner surface of oil pan 20 adjacent to aperture 22.

Glove 30 may be made of any suitable rubber, paper or plastic material, such as neoprene, and may be disposable if desired. Drain pan 20 may be made of any suitably rigid and leakproof material, such as polyethylene.

Using the present invention, it will be appreciated that there is no longer a need to reach over and across the oil pan as the oil is changed. The invention also alleviates clearance issues, which might ordinarily prevent a user's hand from coming in from the side and loosening the drain plug, for example. Also, should the plug fall in the pan, it can be easily retrieved. The invention also allows the user, during draining of the oil pan, to hold up the pan to alleviate any mess when the oil drains out.

It will be appreciated that using the present invention, drain pan oil can be changed in a quick, efficient and relatively mess-free manner. First, user 50 can slide his/her arm 40 within glove 30, and then use the glove to loosen fasteners associated with a portion of crankcase 38 (FIG. 4A), for example. Next, user 50 can remove crankcase drain plug 24 (FIG. 4B), and allow oil from the crankcase to drain into oil pan 20 (FIG. 4C), After the used oil has been removed, the glove can also he used to re-insert the drain plug, and to re-tighten the crankcase fasteners. If necessary, the oil filter can be changed, as well.

The above description is not intended to limit the meaning of the words used in the following claims that define the invention. For example, while various preferred and less preferred embodiments have been described above, persons of ordinary skill in the art will understand that a variety of other designs still falling within the scope of the following claims may be envisioned and used. It is contemplated that future modifications in structure, function or result will exist that are not substantial changes and that all such insubstantial changes in what is claimed are intended to be covered by the claims.

We claim:

1. A drain pan useful for draining oil from an engine, comprising:
a glove attached to a side or top of the pan, the glove residing inside the drain pan, and the glove permitting a user to manipulate items above the pan.

2. The drain pan of claim 1, wherein a base end of the glove is attached to the pan using one or more of the following attachment means: screws, bolts, rivets, adhesives, zippers, buttons or Velcro®.

3. The drain pan of claim 1, wherein the glove comprises one of the following materials: rubber, paper or plastic.

4. The drain pan of claim 3, wherein the glove comprises neoprene.

5. A method of using a drain pan with an attached glove, comprising the steps of
inserting a user's hand into the glove;
using the glove to reach up to loosen fasteners associated with a crankcase of an engine, to allow oil to drain from the crankcase into the drain pan; and
using the glove to remove the drain plug from the drain pan, and allowing oil to drain from the drain pan.

6. The method of claim 5, further comprising the step of using the glove to replace the drain plug, and to tighten the fasteners associated with the crankcase.
